(19) United States
(12) Patent Application Publication
(10) Pub. No.: US 2011/0302764 A1
(43) Pub. Date: Dec. 15, 2011

(54) WOVEN MESH BRAID CONNECTION TOOL

(76) Inventor: Scott Smith, Wisconsin Rapids, WI (US)

(21) Appl. No.: 13/160,956

(22) Filed: Jun. 15, 2011

Related U.S. Application Data
(60) Provisional application No. 61/355,027, filed on Jun. 15, 2010.

(51) Int. Cl. B23P 19/04

(52) U.S. Cl. 29/505; 29/237

(57) ABSTRACT

An apparatus and method for use is provided to remove the flare from the end of a hose to be inserted into a connector. The apparatus serves to align the braids, typically woven of stainless steel mesh, which encompass high pressure hosing such as found in a high pressure gas line. The compressed and aligned strands of mesh can then be easily slid into the receiver of the connector.

### CROSS REFERENCE TO RELATED APPLICATIONS

This application claims priority from U.S. provisional application No. 61/355,027 filed 15 Jun. 2010; entitled Woven Mesh Braid Connection Tool. The entire contents being hereby incorporated by reference and for which benefit of the priority date is claimed.

### FIELD OF THE INVENTION

The present invention relates to improvements in the field of metal working means to assemble or disassemble conduit, and be directed more particularly to improvements in coupling to conduit, particularly to field operations for assembling or joining a coupling and a high pressure braided conduit together.

### BACKGROUND OF THE INVENTION

The relevant art of interest describes various embodiments of a machine for bringing the coupling and conduit together for the purpose of crimping or otherwise attaching the two components.

Typically a conduit suited to high pressure applications such as gas lines and the like is formed with a stainless steel braid woven around the outside of the tube in order to increase resiliency under pressure. Following are some typical examples of the prior art.

U.S. Pat. No. 3,803,699 issued to Rizzo on Apr. 16, 1974 entitled FLEXIBLE HOSE ASSEMBLY MEANS teaches a field assembly tool for joining high pressure flexible hose and assembly fittings. Three truncated extensions attached to interconnected, adjustable, generally triangular frame members are gradually closed upon respective arcuate segments and compress the hose onto a sleeve which has been inserted between the inner, sealing, and outer, structural components of the high pressure hose. This invention is based on a collet approach being a different mode of operation than the current application.

U.S. Pat. No. 4,258,942 issued to Viola on Mar. 31, 1981 entitled THREADED FERRULE HOSE COUPLING teaches A coupling device fitted onto an end of a hose into which a barbed nipple is inserted. The device is a rigid ferrule providing along its inner side two cylindrical portions of different diameters that are joined by a frusto-conical portion. This patent is based on a threaded approach with a flared end for pressing a cable into the receiver end which is the wider of the two cylindrical portions. When a hose with a woven mesh is cut, it has frayed ends and the like which do not easily push forward into the cylinder and become pushed and bunched.

U.S. Pat. No. 5,638,869 issued to Zaborski et al on Jun. 17, 1997 entitled FLEXIABLE METAL HOSE CONNECTOR AND METHOD FOR FORMING SAME teaches and approach very similar to Viola. An end fitting is secured to a flexible metal hose comprised of a corrugated tube enclosed in a tubular braid in a manner that provides a single weld operation. An end of the hose is cut to bring the tube and braid ends into alignment. Thereafter, an end fitting is moved over the hose end and radially swaged into gripping engagement with the hose. A circumferential deep penetration weld integrally secures all the components, namely, the tube, the braid, and the fitting.

Referring particularly to FIG. 15, this second embodiment uses a one-piece, machined end fitting component 90 having a somewhat cylindrical main body section 92 and a reduced diameter cylindrical tube adapter end portion 94. At one end of the main body 92, there is a cylindrical bore 96 which has a diameter that is only slightly greater than the outer diameter of the braided flexible metal hose A′. The diameter is selected so as to allow the hose A′ to be closely and snugly received therein during the subsequent assembly steps. The bore 96 terminates in a radially inward extending shoulder portion 98. A transition section 100 joins the bore 96 with the reduced diameter outlet bore 102 formed centrally of the outlet end portion 94.

In accordance with the subject method of Zaborski, the first step is to cut the braided flexible metal hose A′ to its desired length. The hose, including the braid and the corrugated tubing, can be cut at a crest, root, or flank of a convolution of the corrugated tubing 10′. Zaborski teaches that the cut should be performed in such a way as to leave the end of the braid covering 12′ clean and without a frayed end. Which cannot always be accomplished even by those skilled in the art. It is also desirable, but not absolutely necessary, for the ends of the tube and braid to terminate generally in the same plane.

Zaborski also teaches a tool such as the two-part assembly ring 110 is used to facilitate the installation of the tube A′ into located position within the end fitting 90. The assembly ring 110 comprises two half ring elements 110a and 110b that are shaped so as to provide a conical entrance mouth 112 leading to a circular gripping portion 114.

The process of attaching a connector to a hose requires that the inner diameter of the connector be tightly matched to the outer diameter of the hose to assure a tight connection so as to eliminate leakage. Challenges with the methods and approaches of prior art shown above is the tendency of the braiding around the outside of the hose to fray. To fray can be defined as “to separate the threads at the edge of” the cut in the hose. Such fraying causes the end to flare wider than the diameter of the starting hose. Therefore, any approach in which the hose with a flared end is pushed into a connector, harness, or even a conical entrance as taught by Zaborski, causes the threads to be pushed back and bunched together. Therefore a solution is desired whereby the braided portion is pulled back into a sleeve thus aligning any frayed fibers to remove the flare before insertion into the connector. This can then be followed by the coupling step.

### SUMMARY OF THE INVENTION

There is hereby provided a multiple of apparati having a common method. The method being to remove the flare from the end of the hose, then to move or slide the hose into the connector through an orifice which substantially matches the outer diameter of the hose being used.

In the art, these hoses can come in a variety of sizes, therefore it may be advantageous to have a tool capable of accommodating a multiple of hose sizes, typically ranging from 3/16 inch diameter to 1⅛ inch diameter by ⅛ inch increments. This discussion on typical sizes is not intended to be limiting as, for example, a metric scale may be used, or larger or smaller sizes of hose may be chosen.

### BRIEF DESCRIPTION OF THE DRAWINGS

An understanding of the present invention may be obtained by reference to the accompanying drawings, when considered in conjunction with the subsequent, detailed description, in which:

FIG. 1A shows a perspective view of a coupling device of the present invention being in the open position;

FIG. 1B shows a close-up view of the subject matter of FIG. 1A;

FIG. 2 shows a side view of the subject matter of FIG. 1B being in the closed position;

FIG. 3A, shows a perspective view of an assembly step comprising seating a hose into the device;

FIG. 3B, shows a perspective view of an assembly step comprising setting a hose into the arcuate tube of the device;

FIG. 3C, shows a face on perspective view of the assembly step shown in FIG. 3B showing the frayed portion being collected by the arcuate tube;

FIG. 3D, shows a perspective view of an assembly step comprising mounting a connector to the arbor portion of the device;

FIG. 3E, shows a perspective view of an assembly step comprising the hose being mated with the connector and ready for attaching or crimping;

FIG. 4 shows a perspective view of an alternate embodiment of the current invention having multiple sizes of arcuate portions;

FIG. 5A shows a perspective view of the embodiment of FIG. 4 having multiple diameters of tubing being assembled comprising the seating step;

FIG. 5B shows a perspective view of the embodiment of FIG. 4 having multiple diameters of tubing being assembled comprising the setting step;

FIG. 5C shows a perspective view of the embodiment of FIG. 4 having multiple diameters of tubing being assembled comprising the mounting step;

FIG. 5D shows a perspective views of the embodiment of FIG. 4 having multiple diameters of tubing being assembled comprising the attaching step;

FIG. 5E shows a perspective views of the embodiment of FIG. 4 having multiple diameters of tubing being opened upon completion of the process;

FIG. 6 shows a perspective view of the closing apparati for a third embodiment of the present invention;

FIG. 7 shows a perspective view of the embodiment of FIG. 6 having a portion of the various complimentary hardware components;

FIG. 8 shows a perspective view of the embodiment of FIG. 6 being seated;

FIG. 9 shows a perspective view of the embodiment shown in FIG. 8 being prepared for the attaching process;

FIG. 10 shows a perspective view of the alternate embodiment shown in FIG. 9 being attached.

FIG. 11 shows a face on and top through section of the embodiment of FIG. 4.

For purposes of clarity and brevity, like elements and components will bear the same designations and numbering throughout the Figures.

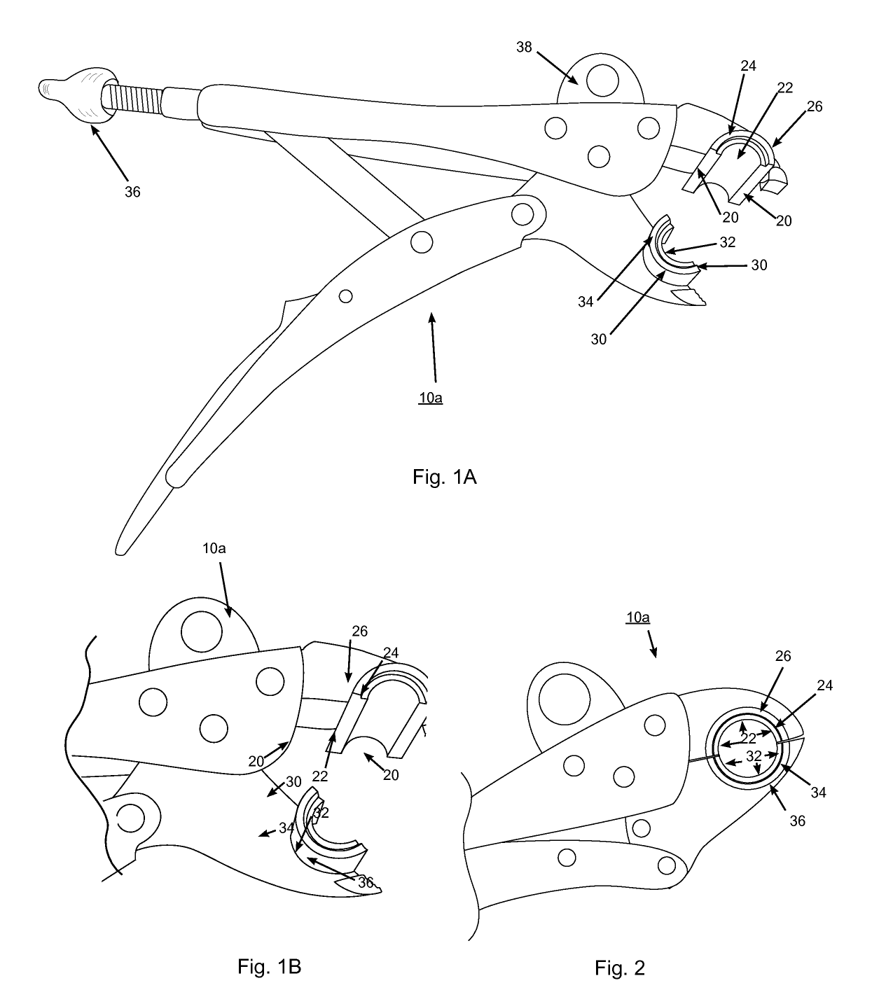

FIGS. 1-3 show an embodiment for the present invention having a closing apparatus (10a) patterned after a vise grip found in many tool chests. In this embodiment, the jaws of the vice grip are replaced by a primary face region (20) and an opposing face region (30) being substantially flat and come together when in the closed position. An arcuate cavity (22) and an opposing arcuate cavity (32) being formed such that when the face regions (20) and (30) come together a cylinder, annulus or tubular region are formed. It is preferred that the arcuate cavities (22) and (32) be sized to fit snuggly about the outside diameter of a section of braided tubing (12) of a specific size, such that the tubing (12) can slide along the cylinder with a moderate amount of force.

An arbor portion (24) and an opposing arbor portion (34) are formed at one end of the cavity formed by (22) and (32). The arbor portions (24) and (34) is preferably sized to allow a connector (14) to slide into the arbor (24) (34) and seat next to the cylindrical cavity (22) (32) with the inside diameter of the connector (14) substantially matching the diameter of the cavity (22) (32). It should be noted that when the use of primary and opposing though represented in the drawings as top and bottom, can be used equivalently in many and varied orientations.

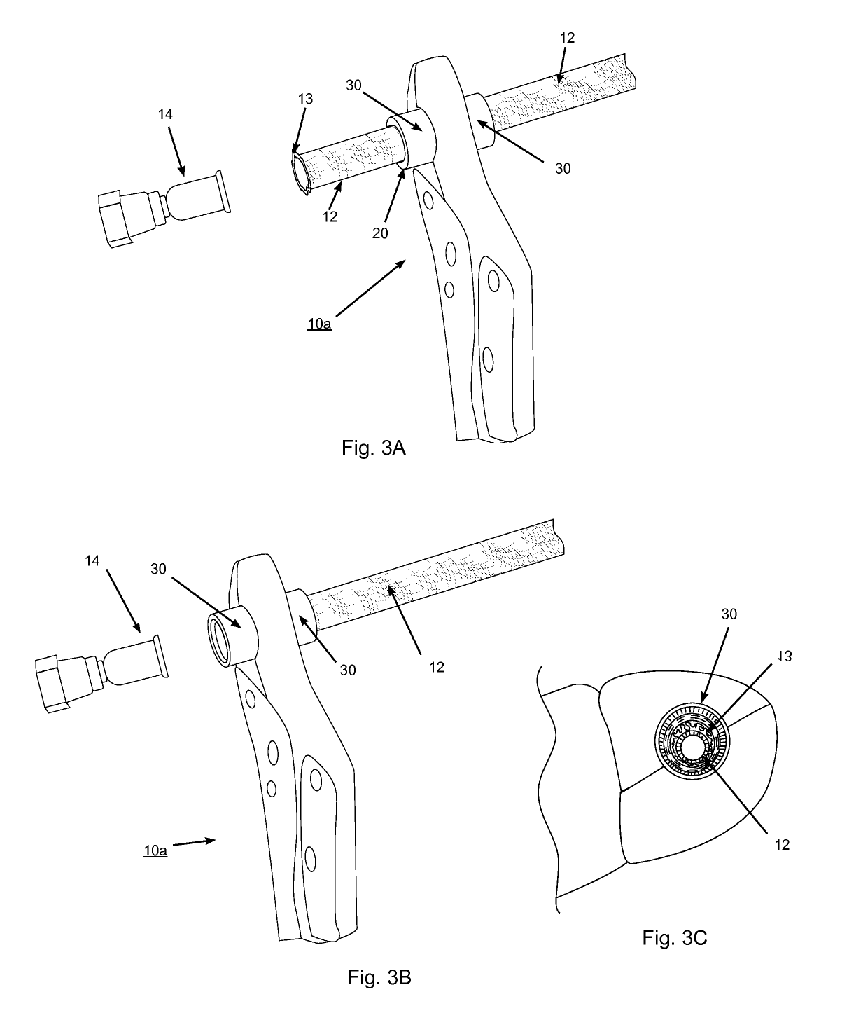

The primary and opposing elements are brought together, such that when the grip is closed such as shown in FIG. 2, a generally annular or tubular member is formed (22) (32) generally sized to the outside diameter of the braided tubing being worked, and having an arbor portion (24) (34) generally sized to receive and center a connector (14) for mating with the tubing (12). A hanging apparatus (38) can be added for convenience. As a system, the various components can be color coded to correspond with various diameters of hose.

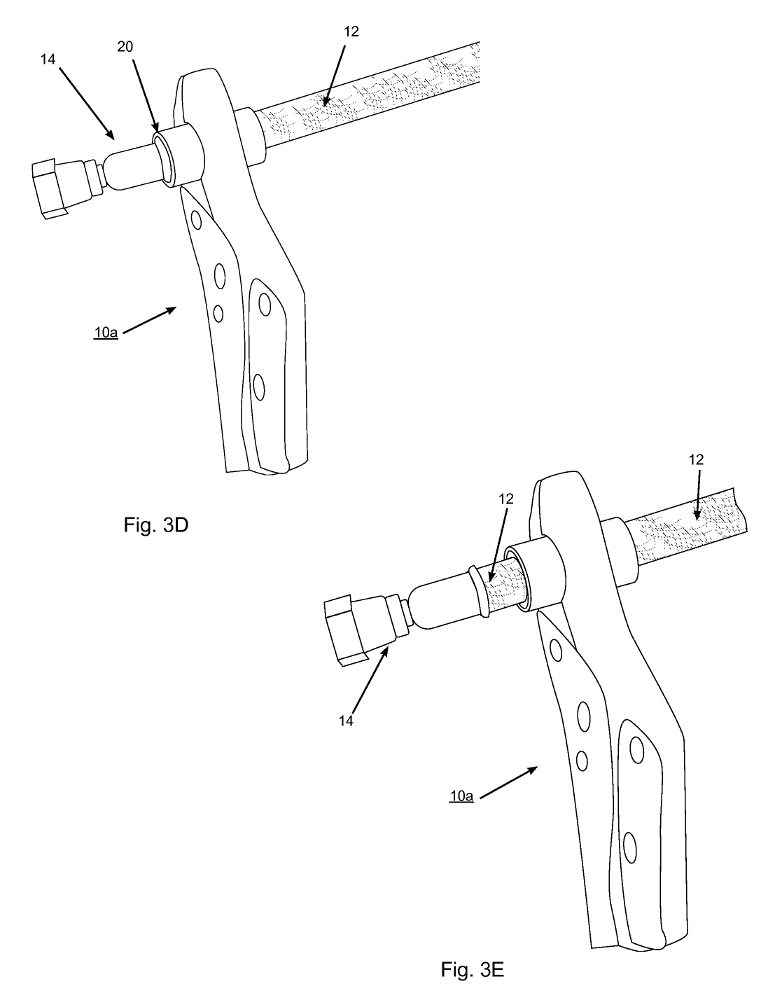

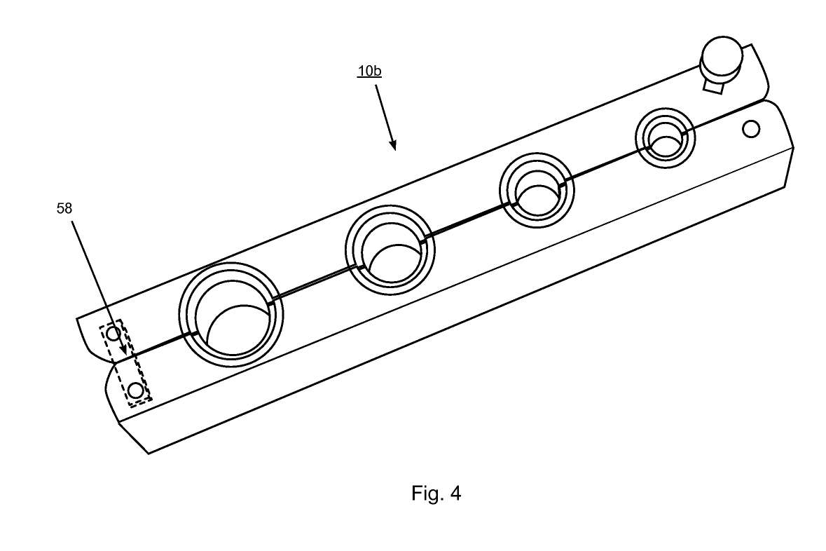

As a method of operation, the braided tubing (12) having an end which is cut off and generally forming a frayed end (13), and generally having loose ends which flare or spread beyond the diameter of the outside of the tube (12). The frayed end (13) is brought in proximity with the opposing elements (20's) and (30's), with the frayed end (13) in proximity with the arbor portion (24) (34). The apparatus (10) is closed around a middle portion of the tube (12), generally close to but not at, the end of the tube (12). The tube is then slid into the arcuate cavity from the middle toward the end portion, (a direction referred to as back) which generally aligns and gathers the loose ends as illustrated in FIG. 3C. At this step, or other suitable step in the sequence, a spreader (36) can be used for re-rounding the cut hose (12) which may have been crushed or crimped during the cutting process.

A connector (14) is then mounted into the arbor portion (24) (34) of the device, and the now collected, compressed, and gathered braids of the formerly frayed end (13), are slid forward easily into the connector (14). The connector (14) is then affixed by crimping with a crimping tool or other such device and formed as a permanent connection.

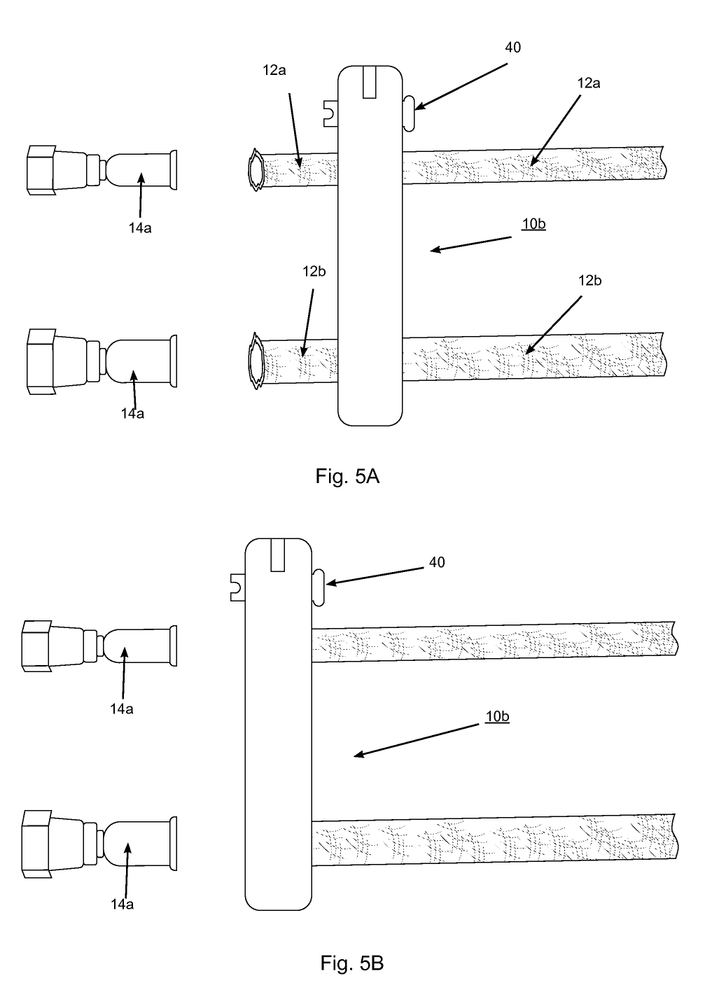

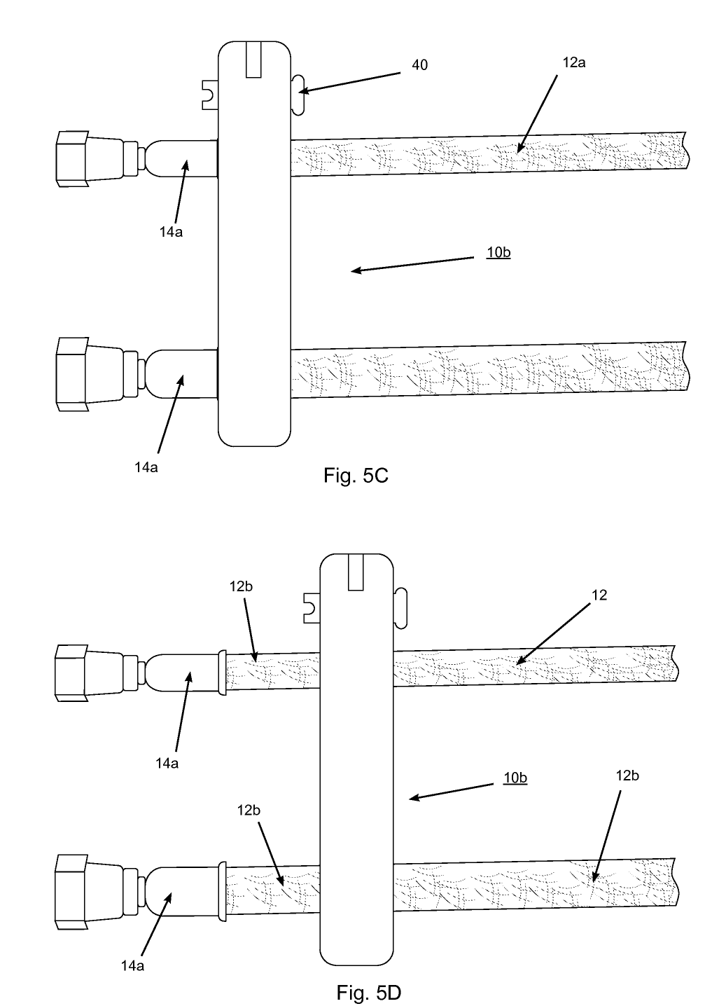

FIGS. 4-5 and 11, show an alternate embodiment of the present invention having a closing apparatus (10b) being a separately formed tool and having multiple sizes of arcuate portions (22) generally ranging in size for fittings from approximately 3/16 inch to a 1⅛ inch connector (14) (14a). This embodiment further has a latch mechanism (40) and hinges (58) for aiding the closing apparatus.

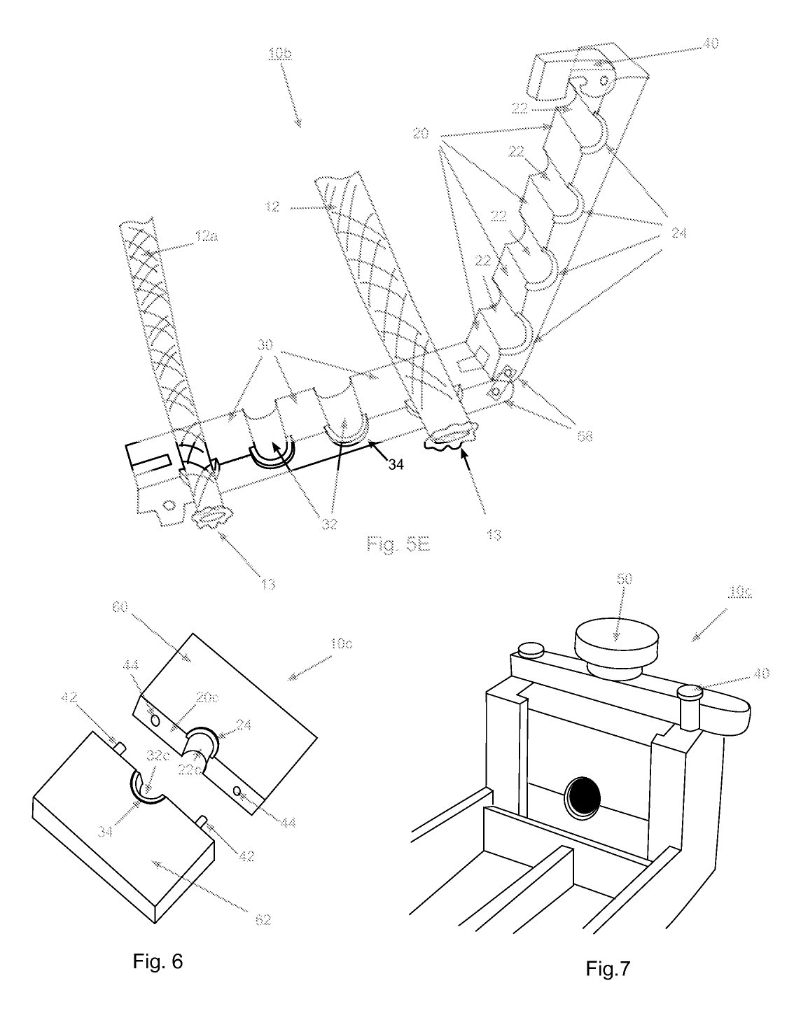

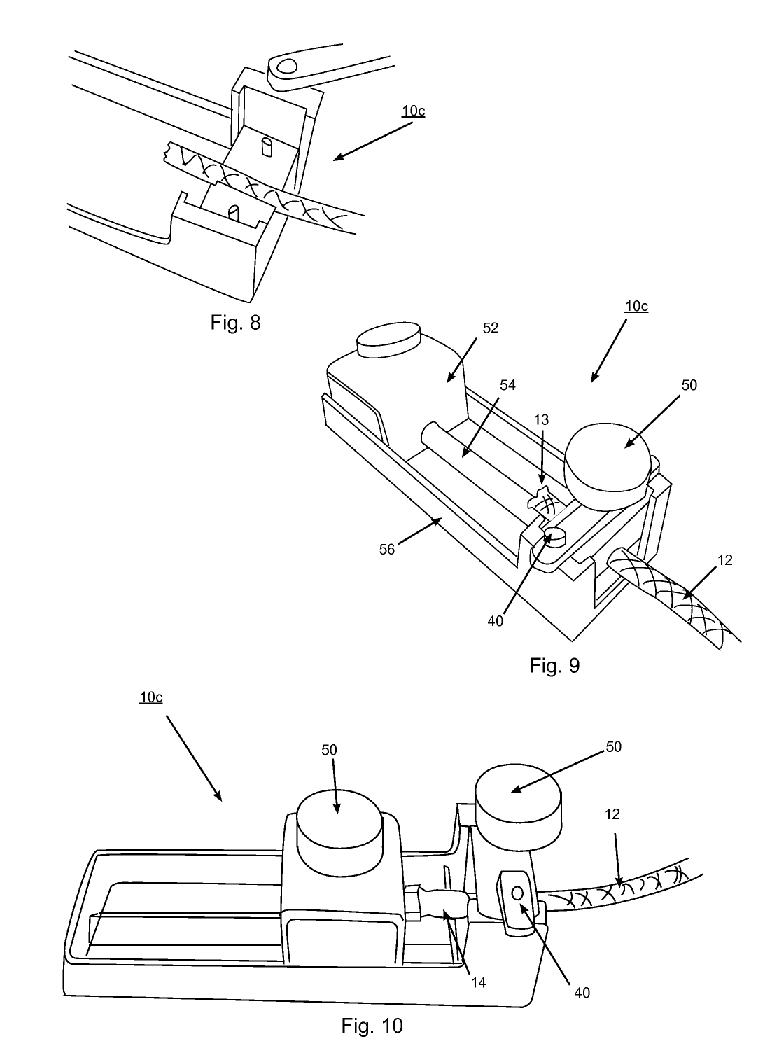

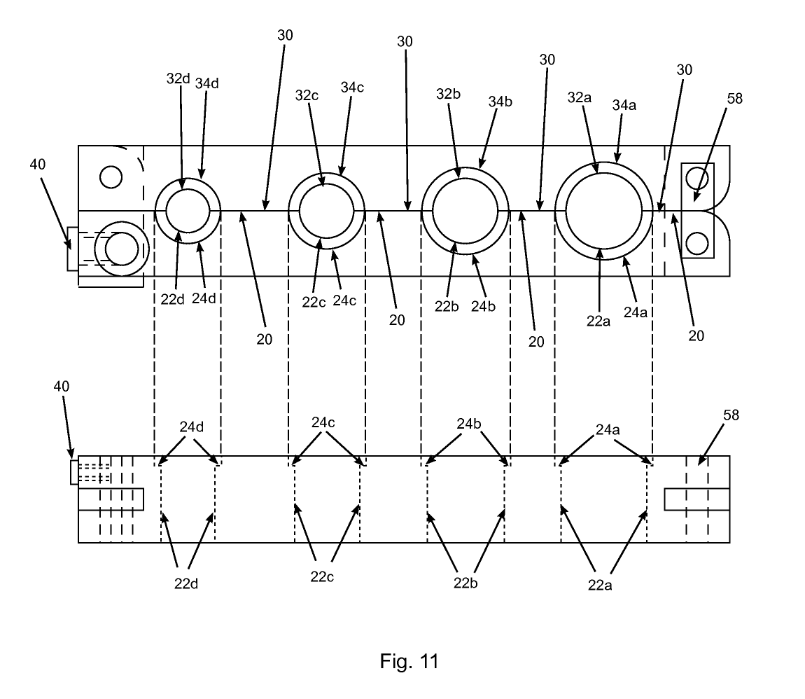

FIGS. 6 through 10 show yet another embodiment having a closing apparatus (10c) and the face regions (20) (30) being formed from substantially separate blocks. The blocks may be aligned by means of a pin (42) and bore (44). This embodiment further has a base member (56) for mounting, a press (52) being in connection with a guide (54) for aiding in the alignment and mating of the tubing. A knob (50) or tightening and holding the top (60) and bottom (62) plates is also provided.

### CONCLUSION, RAMIFICATIONS, AND SCOPE

Although the present invention has been described, those skilled in the art will understand that various changes, substitutions, and alterations herein may be made without departing from the spirit and scope of the invention in its broadest form.

Having thus described the invention, what is desired to be protected by Letters Patent is presented in the subsequently appended claims.

What is claimed is:

1. A method for joining a tube having an exterior woven mesh braiding with a connector comprising;
(i) providing a closing apparatus
(ii) providing at least two portions in connection with the closing apparatus that, when brought together form an arcuate cavity having an arbor portion disposed at one end of the cavity,
(iii) providing a braided tube having an end,
(iv) closing the portions around a section of the braided tube near, but not at the end of the tube,
(v) sliding the tube such that said end is situated in the arcuate cavity,
(vi) providing a connector and sliding the connector into the arbor portion, and
(vii) sliding the tube such that the end of the tube mates with the connector.

2. The method in accordance with claim 1 further comprising the step of re-rounding the hose before the step of sliding the tube such that the end of the tube mates with the connector.

3. The method in accordance with claim 2 further comprising a spreader for rounding the interior of the hose.

4. The method in accordance with claim 2 further comprising the step of affixing the connector to the hose by means of crimping.

5. The method in accordance with claim 4 further comprising a closing apparatus having a multiple of sizes of arcuate portions being coordinated with various sizes of tubing.

6. The method in accordance with claim 5 wherein the multiple of sizes range between 3/16 inch and 1⅛ inch.

7. The method in accordance with claim 6 further comprising the multiple of sizes of arcuate portions are color coded.

8. The method in accordance with claim 4 further comprising a latch for holding the closing apparatus in a closed position.

9. The method in accordance with claim 8 further comprising a guide for aiding alignment.

10. An apparatus for joining a section of tubing having an exterior woven mesh braiding with a connector comprising:
(i) a closing apparatus;
(ii) the closing apparatus comprising two portions that when brought together form a tubular cavity, the tubular cavity being substantially matched with outside diameter of a tubing to be mated to a connector;
(iii) the tubular cavity having an arbor portion disposed at one end of the cavity for receiving a connector, the arbor portion being sized and adapted for sliding the connector into and out of the arbor portion, and the connector being matched such that the inside diameter of the connector is matched with the diameter of the tubular cavity.

11. The apparatus in accordance with claim 10 further comprising a spreader for rounding the interior at the end of the hose.

12. The apparatus in accordance with claim 11 further comprising a hanging apparatus.

13. The apparatus in accordance with claim 11 comprising multiple sizes of tubular cavities.

14. The apparatus in accordance with claim 13 wherein the multiple sizes of tubular cavities range in diameter between 3/16 inch and 1⅛ inches.

15. The apparatus in accordance with claim 13 wherein the multiple sizes of tubular cavities are color coded.

16. The apparatus in accordance with claim 13 further comprising a latch.

17. The apparatus in accordance with claim 17 further comprising a knob for holding a series of top and bottom plates.
